(19) United States
(12) Patent Application Publication
(10) Pub. No.: US 2023/0221583 A1
(43) Pub. Date: Jul. 13, 2023

(54) SMART GLASSES TO ASSIST THOSE WHO ARE DEAF OR HARD OF HEARING

(71) Applicant: Hearing Glasses LLC, Mankato, MN (US)

(72) Inventors: Abdelrahman Samy Elkenawy, Mankato, MN (US); Kaitlyn Quinn Gloege, Brandon, SD (US)

(21) Appl. No.: 18/058,502

(22) Filed: Nov. 23, 2022

Related U.S. Application Data
(60) Provisional application No. 63/264,446, filed on Nov. 23, 2021.

(51) Int. Cl. G02C 11/06; G02B 27/01; H04R 25/00

(52) U.S. Cl. CPC G02C 11/06; G02B 27/017; H04R 25/40; G02B 2027/014

(57) ABSTRACT

A wearable apparatus for hearing assistance, such as hearing glasses, is described. The wearable apparatus includes two microphones which are separated by a separation distance from each other. A display is included which is configured to present images in front of a user’s eyes. The wearable apparatus also has a processor to receive a first sound at a first time from a first microphone, receive the first sound at a second time from a second microphone, determine a direction of origin of the first sound based on the first time, the second time and the separation distance, and provide a visual indication of the direction of origin of the first sound using the display. The processor may also generate captions based on received speech and display the captions using the display.

### STATEMENT OF RELATED INVENTIONS

This application is a U.S. nonprovisional application which claims the benefit of U.S. Provisional Application No. 63/264,446, filed Nov. 23, 2021, and is hereby incorporated by reference.

### BACKGROUND

Various embodiments relate generally to hearing assistance devices systems, methods, devices and computer programs and, more specifically, relate to smart glasses to provide visual-based augmented reality systems to assist hearing.

This section is intended to provide a background or context. The description may include concepts that may be pursued, but have not necessarily been previously conceived or pursued. Unless indicated otherwise, what is described in this section is not deemed prior art to the description and claims and is not admitted to be prior art by inclusion in this section.

Currently, those who are deaf or hard of hearing have access to a limited number of devices to assist them, mostly limited to hearing aids and cochlear implants. Both of these devices are made for specific types of hearing loss and may not work for everyone. Hearing Aids face many issues including feedback, difficulties getting used to them, and frustrations when worn alongside glasses. Cochlear implants require extremely expensive surgery to place the implant. Even after going through with the surgery, the cochlear implants are not guaranteed to work and another surgery may be required later on.

Hearing Aids and Cochlear Implants both help to boost one’s hearing but it lacks in many areas. The users may still struggle to determine where a noise is coming from, hearing someone trying to get their attention, and hearing and identifying other day-to-day noises like sirens, door knocks, and car horns. These devices both lack the ability to be selective in the noises they amplify. Instead of only amplifying the noises that matter, they amplify unwanted sounds like background noise as well.

There are also smartphone apps available to those with hearing loss that convert sound to text. These apps require the user to be connected to the internet and do not have a high range of sound captioning due to hardware limitations on the smartphone.

Many people suffer from varying degrees of hearing loss. According to the National Association for the Deaf, 48 million people in the US and 477 million worldwide have a certain degree of hearing loss. 80% of types of hearing loss can be treated with hearing aids, but only 25% of those individuals impacted actually use them. Adults who have an assistive device for their hearing loss show reduced depression symptoms. About 2-4 out of every 1,000 people in the US are functionally deaf. Most of these people became deaf later in life. Furthermore, it is estimated that by 2050, over 900 million people will have disabling hearing loss.

1 million people in the US use ASL as their main way to communicate. When comparing the population of people communicating through ASL to the population of people who do not know sign language, the numbers vary heavily. That leaves a lot of people that cannot be communicated with, without an interpreter or other resources. 1 in 4 deaf people has left a job due to discrimination against their hearing loss.

44.4% of individuals with severe hearing loss did not graduate high school in the US. 5.1% of the deaf or hard of hearing community graduated college. 98% of those who are deaf do not receive education in sign language, 72% of families with deaf children do not sign with them, 70% of deaf people do not work or are unemployed.

What is needed are additional ways to provide assistance for those suffering hearing loss.

### SUMMARY

The below summary is merely representative and non-limiting.

The above problems are overcome, and other advantages may be realized, by the use of the embodiments.

In a first aspect, an embodiment provides wearable apparatus for hearing assistance, such as glasses. The wearable apparatus includes two (or more) microphones which are separated by a separation distance from each other. A display is included which is configured to present images in front of a user’s eyes. The wearable apparatus also has a processor to receive a first sound at a first time from a first microphone, receive the first sound at a second time from a second microphone, determine a direction of origin of the first sound based on the first time, the second time and the separation distance, and provide a visual indication of the direction of origin of the first sound using the display. If additional microphones are provided, they may also be used to determine the direction of origin (e.g., based on the time difference between receiving the first sound at a third microphone and the separation of the third microphone from the first and/or the second microphones).

In another aspect, an embodiment provides a wearable apparatus for hearing assistance, such as glasses. The wearable apparatus includes at least one microphone; a display configured to present images in front of a user’s eyes; and a processor. The processor is configured to receive speech from the at least one microphone, generate captions based on the speech, and display the captions using the display.

In a further aspect, an embodiment provides a method for hearing assistance. The method includes providing a wearable device, such as glasses. The device has two microphones which are located a separation distance apart. The device also has a display configured to present images in front of a user’s eyes. A first sound is received at a first time from a first microphone. The first sound is received at a second time from the second microphone. The processor determines a direction of origin of the first sound based on the first time, the second time and the separation distance, and provides a visual indication of the direction of origin of the first sound using the display.

### BRIEF DESCRIPTION OF THE DRAWINGS

Aspects of the described embodiments are more evident in the following description, when read in conjunction with the attached Figures.

FIG. 1 shows one design for the hearing glasses.

FIGS. 2A and 2B, collective referred to as FIGS. 2, show front (FIG. 2A) and side (FIG. 2B) perspectives of the glasses.

FIG. 3 shows another view of the glasses.

FIG. 4 shows a first image from a user perspective.

FIG. 5 shows another image from a user perspective with sound source indicators.

FIGS. 6A-6D, collectively referred to as FIGS. 6, show various captions which may be provided.

FIG. 7 shows a flow chart 700 for an algorithm which may be used during the operation of the hearing glasses.

FIG. 8 shows a flow chart 800 for four different modes of operation.

FIG. 9 illustrates a general outline of the components of the hearing glasses.

FIG. 10 illustrates another diagram showing additional interactions between the components.

### DETAILED DESCRIPTION

Various embodiments enable smart glasses to provide visual-based augmented reality (AR) systems to assist hearing. These smart glasses, also referred to as hearing glasses, can be used to caption real-life conversations and sounds to provide better inclusion and safety for the user. People who are deaf or hard of hearing can use hearing glasses to fully take part in conversations with those around them without the need for an interpreter. They also can be alerted of day-to-day noises such as car horns, sirens, and public announcements. All of this can be provided in a discrete way looking similar to everyday glasses made for any type of hearing loss.

In addition to captioning voices and sounds, hearing glasses can be used to guide the users to a sound’s origin through visual indicators or vibrations on the glasses. Hearing glasses can be used by anyone, not only those who are deaf or hard of hearing. These uses include factory use, manufacturing, and other loud environments. In these instances, companies can broadcast announcements to their workers in the form of captions on the glasses and get their attention more efficiently. This improves safety and efficiency within these industries.

Various embodiments provide a means for captioning conversations in real-time for the users and displaying the text in front of them to read. The glasses can also indicate background noises by displaying symbols or text on the glasses. These noises include emergency-related noises like sirens, alarms, and public announcements; personalized noises for parents including crying, screaming or yelling; and miscellaneous day-to-day noises including car horns, door knocks, footsteps, clapping, and music. The glasses can calculate and guide the user to the sound source/origin.

The glasses may also provide information to highlight personalized elements to the user like names, nicknames, and references. The glasses can listen for certain keywords and notify the user when those keywords are heard. Another feature is the ability to recognize voices familiar to the user including family members or friends and indicating who is talking to them.

The hearing glasses can be expanded to be used in markets other than those who are deaf or hard of hearing. These additional markets include factory use, manufacturing, and other areas working in loud environments. In these instances, companies can broadcast announcements to their workers in the form of captions on the glasses and get their attention more efficiently.

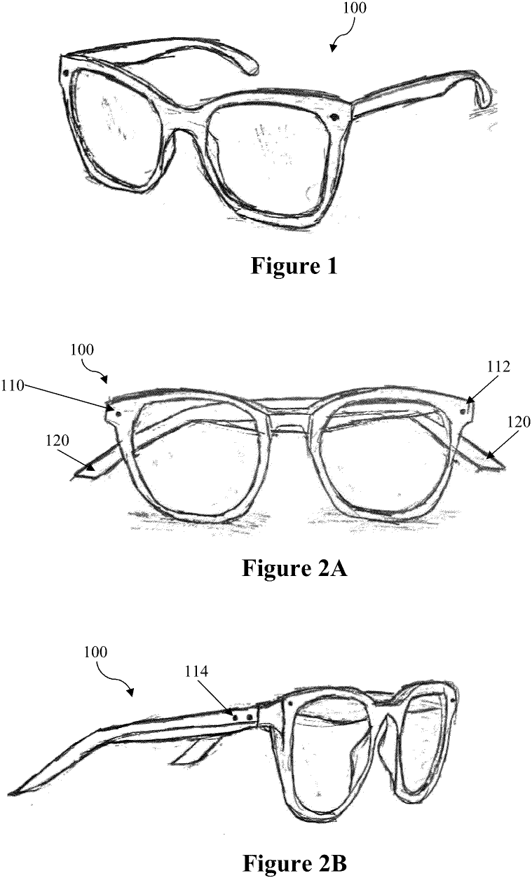

FIG. 1 shows one design for the hearing glasses 100. These glasses 100 blend in with everyday glasses while still containing the hardware for use. These glasses 100 can be worn by users without indicating any type of hearing loss. The weight of the glasses 100 may be slightly heavier than regular glasses but still comfortable to wear for an entire day.

With this small design, the glasses can make use of small, lightweight hardware components. The weight of the glasses may be heavier than ordinary glasses a user would be used to wearing, however still comfortable to wear and secure to the user.

FIGS. 2A and 2B, collective referred to as FIGS. 2, show two different perspectives of the glasses. An observer looking at someone wearing hearing glasses from both the front (FIG. 2A) and side (FIG. 2B) will see a normal-looking pair of glasses 100. There are two small microphones 110, 112 on the outer edges that are barely noticeable. From most angles, an outside observer will not be able to tell nor recognize the glasses display. The arms 120 of the glasses may be slightly bigger than normal glasses in order to fit the hardware components. These arms 120 can also include a few buttons for the user to interact with the glasses.

In FIGS. 2, the hearing glasses feature multiple microphones 110, 112, 114 which can be used to calculate the sound origin. These microphones 110, 112, 114 can be on the two opposite sides of the glasses. The microphones 110, 112, 114 are used to calculate a sound’s origin similar to the way humans are able to sense the originating direction of noises around them.

If there is a sound coming from the right side of the glasses, the microphone 110 on the right side captures the sound wave slightly faster than the mic 112 on the left. Because of this slight variation of the sound being captured, the glasses are able to estimate the sound origin. The indications for sound origin can either be indicated by visual arrows on the lenses of the glasses or by vibration on either side of the glasses indicating the direction to the sound source.

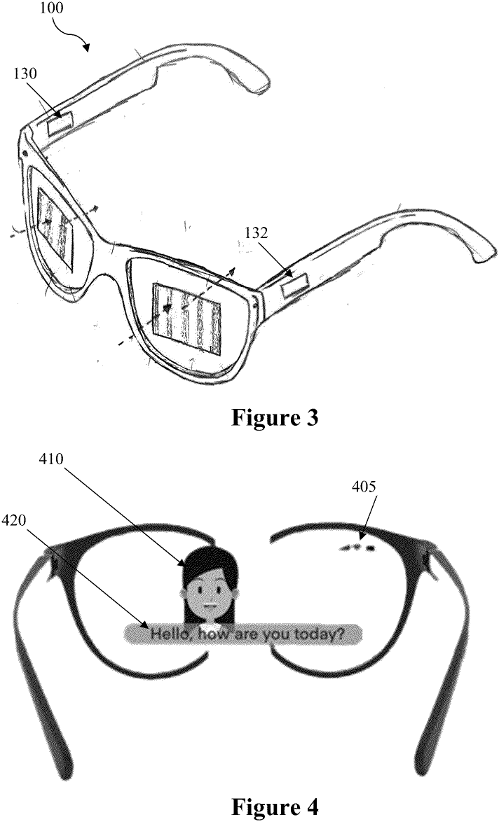

FIG. 3 shows another view of the glasses 100 and indicates hardware components 130 and where they are located. These components include a microprocessor, Bluetooth module, microphones, batteries, charging port, and buttons 132.

The glasses can be used with microprocessors of various types. One type of microprocessor that can be used is able to support running multiple machine learning algorithms in parallel (using multi-threading) alongside captioning sound, calculating sound origin, and sending the display output. Another microprocessor may handle sound captioning, Bluetooth communication, and display output.

The microphones 110, 112, 114 can capture audio from up to 12 feet away or a sound as quiet as 10 dB and as loud as 120 dB. The battery supports the operation of the glasses for an entire day. A charging port, such as a USB type C, may be provided in the arms 120.

The models may have 3 or more buttons. One button can be for power and used to turn the glasses on and off. Next, a button may be provided to adjust the mode of the glasses, such as to select silent mode, driving mode, focus mode, and full function mode. A third button can be a tuning dial (or a paired set of buttons) that allows the user to adjust sensitivity depending on their environment. For example, when in a bar the user may turn the sensitivity down compared to when in a quieter environment like a home.

When an internet connection is available, the glasses can give the user an option to run machine learning algorithms on the cloud in order to save battery resources and/or provide more accurate analysis of sounds (e.g., captioning, sound classification, and sound origin indications, etc.). The functionality of the glasses can be implemented on other AR platforms.

FIG. 4 shows the glasses from the user’s point of view. As shown in FIG. 4, the speaker 410 has their words detected by the glasses 100 and a text string (or caption) 420 of what they are saying is provided.

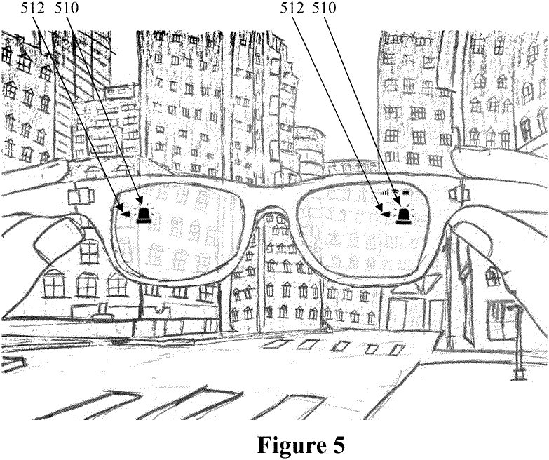

FIG. 5 shows another image from a user perspective with sound source indicators.

The user perspective can include constant visuals and changing visuals. While wearing the glasses, the user can have constant visual status information 405 provide such as to show the battery level of the glasses, the time, and signal strength (e.g., Wi-Fi and/or cellular signals strength). Other information, such as sound origin direction, text strings 420, etc. may be changed or shown when relevant.

The glasses can provide changing/moving visuals 510 such as graphics representing car horns, sirens, or door knocks as well as a directional indicator 512 for the sound source. The location of the visual 510 may also be used to provide a direction indicator, e.g., for sounds detected on the left side, the visuals 510 may be presented on the left side of the lens.

Pre-defined keywords including names or nicknames can be represented in the text string 420 using different colors than other detected words. Familiar voices to the user that are predefined, such as parents, kids, friends, etc., can be recognized and highlighted in specific colors when displayed to indicate who is talking to the user.

A first option for displaying visuals is using augmented reality and displaying text as 3D objects in front of the lenses. Another option is directly projecting text on the lenses using a micro projector and reflecting the text to the wearer’s eyes. These projectors can be contained in the arms 120 of the glasses 100.

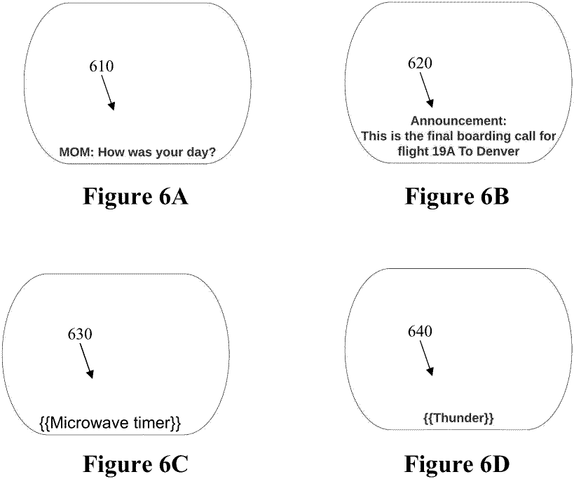

FIGS. 6A-6D, collectively referred to as FIGS. 6, show various captions which may be provided. FIG. 6A shows a caption 610 where the speaker’s name, Mom, is provided with the text of the speech. The name may be colored or otherwise highlighted as discussed above. FIG. 6B shows an announcement caption 620. Keywords in the caption 620 may be emphasized such as the flight number, 19A, or the destination, Denver, based on the user’s settings. FIGS. 6C and 6D provide indications of various sounds, such as a microwave timer alert 630 and a thunderclap 640.

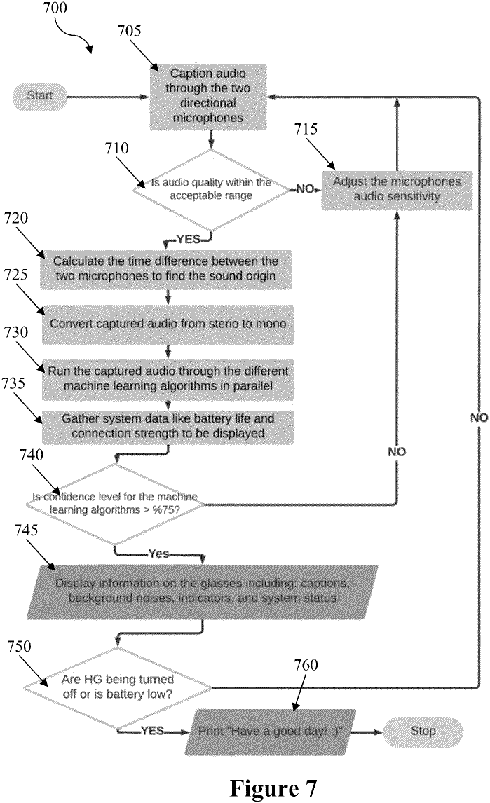

FIG. 7 shows a flow chart 700 for an algorithm which may be used during the operation of the hearing glasses. Once the glasses are powered on, an audio adjustment process takes place in which the microphones start recording audio 705, and then the software checks the audio quality and based on the quality 710. If the quality is too low, the capturing sensitivity is adjusted 715. Then, a sound source calculation process starts comparing the audio from the right and left channels; based on the time difference, the sound source is determined 720. Next, the audio is converted from stereo to mono 725 in order for it to run through the different machine learning algorithms 730. There are two different machine learning algorithms that run in parallel. The first is to caption audio, and the second is to classify sound. If the confidence level of the machine learning algorithm is above 75% 740, the data is displayed on the lenses 745.

Additional steps may be taken, for example, system data may be gathered 735 prior to displaying the information. Likewise, the glasses may detect when they are being turned off or the battery is too low 750 and a farewell message (e.g., “Have a good day! :)”) displayed 760.

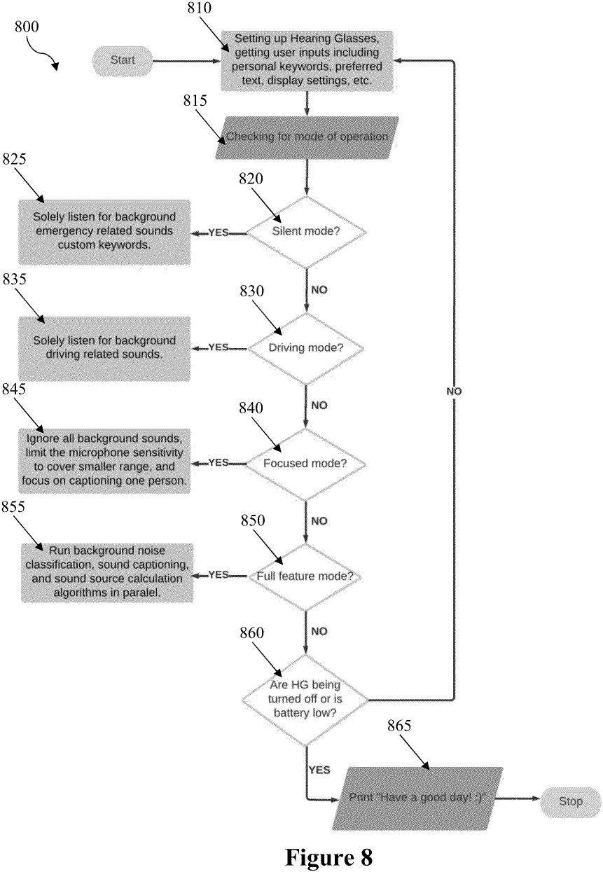

FIG. 8 shows a flow chart 800 for the four different modes of operation and how the glasses keep checking for user inputs. The user begins by setting up the hearing glasses by providing various information, such as, preferences, keywords, settings, etc. 810. When operating the glasses check for the currently selected mode of operation 815. If set to silent mode 820, the glasses stop captioning the audio being heard 825. However, the glasses still listen and display preconfigured keywords and emergency-related noises. If set to driving mode, which is used to limit distractions for the user while they are driving, 830 only displays sound related to driving including car horns, sirens, and alarms are shown 835. If the glasses determine they are set for focused mode 840, the glasses are intended to be used in noisy environments and limits the captioning range to the people you are talking with 845. For example, in a busy restaurant, you will want to only understand your waiter and the people you are with. When the glasses are set to a full feature mode 850, they utilize all available features including captioning, displaying background noises, indicating the sound source, and system status 855. The glasses may also detect when they are being turned off or the battery is too low 860 and a farewell message (e.g., “Have a good day! :)”) displayed 865.

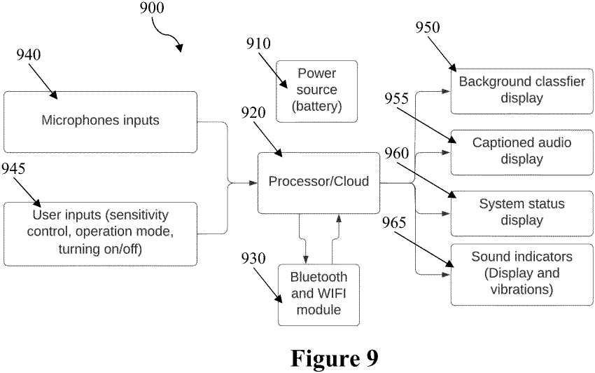

FIG. 9 illustrates a general outline 900 of the components of the hearing glasses. The outline 900 indicates how the components may be connected and how they communicate together. The microprocessor 920 takes input from both the microphones 940 and the user 945 (e.g., using buttons). The microprocessor 920 can rely on external help for handling computations using a remote communication module, such as Bluetooth or Wi-Fi connection 930. Then, the microprocessor 920 can display four layers of output for the user including the background noise classifications 950, captioned audio 955, system status 960, and sound source indicators 960. The processor 920, remote communication module, and display device may be powered by a power source 910, such as a battery.

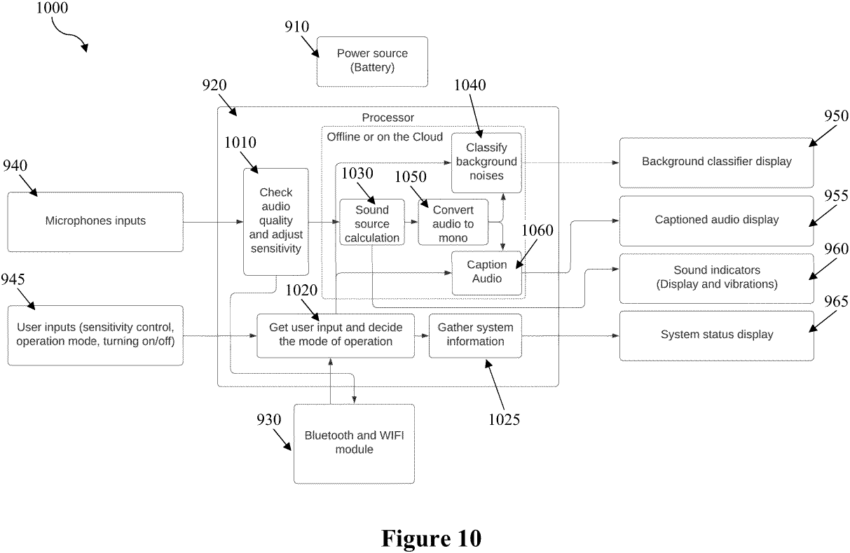

FIG. 10 illustrates another diagram 1000 showing additional interactions between the components. Each one of the four layers of display 950, 955, 960, 965 relies on separate components of the microprocessor and how the sound gets filtered and adjusted before going through the voice classification and machine learning algorithms. The user inputs 945 can be entered through both physical buttons on the glasses and a smartphone app.

The hearing glasses can allow the user to utilize a smartphone app to customize the glasses to their preferred settings and configure the glasses for internet access. For some embodiments, this app can be active while the glasses are in use (for example, to provide additional processing power) or the app may be used only for configurations and customizations. Some of the features have the capability to run either offline, on the cloud or remotely, such as via the phone app.

Data from the microphone inputs 940 can be checked for quality and the microphone sensitivity adjusted accordingly 1010. The microphone data is then used to calculate the source 1030 and converted to mono 1050. Once converted the data the background noises are classified 1040 and/or audio is captioned 1060. User input and operational settings 1020 may be used to assist classification of the background noises 1040 and captioning of audio 1060. User input and operational settings 1020 may also be used to gather system information 1025 (e.g., for system status display 965).

Various embodiments enable hearing glasses to provide hearing assistance displays (or haptic feedback). In one non-limiting example, when a user is wearing the glasses and someone is talking to them or there are noises occurring around them, two (or more) microphones in the frames of the glasses capture the noise. Once the microphones capture the sound, various algorithms run in parallel. A first algorithm is used to caption any voices and turn them into text. A second algorithm classifies the important background noises being heard and/or identifies custom keywords the user defined like their personal name and nicknames. A third algorithm can calculate the sound origin by determining the time difference of sound arrival between the two (or more) microphones and estimating a direction of the sound. These three algorithms can work offline in a way that the users are not required to have internet connectivity all the time.

After the algorithms are complete, information can be displayed on the glasses in the form of text and symbols as well as arrows and vibrations to indicate sound origin. Hearing glasses can have the ability to incorporate the user’s prescription into the lenses and the way the words are displayed can be adjusted as needed. Hearing glasses software can be used on other AR platforms like Microsoft Hololens, Meta VR headsets, etc.

An embodiment provides wearable apparatus for hearing assistance, such as glasses. The wearable apparatus includes two microphones which are separated by a separation distance from each other. A display is included which is configured to present images in front of a user’s eyes (for example, when worn as part of hearing glasses or an AR headset). The wearable apparatus also has a processor to receive a first sound at a first time from a first microphone, receive the first sound at a second time from a second microphone, determine a direction of origin of the first sound based on the first time, the second time and the separation distance, and provide a visual indication of the direction of origin of the first sound using the display.

In another embodiment of the apparatus above, the processor is further configured to identify the first sound and to provide an indication of an identity of the first sound using the display.

In a further embodiment of any one of the apparatuses above, the apparatus further comprises at least two vibration generators, and the processor is further configured to providing a vibrational indicator of the direction of origin of the first sound using the at least two vibration generators.

In another embodiment of any one of the apparatuses above, the processor is further configured to generate captions based on the first sound and to display the captions using the display. The processor may further be configured to identify keywords within the captions and displaying the captions comprises emphasizing the keywords. Emphasizing the keywords may include displaying the keywords in a colored font, bold, and/or all capital letters.

In a further embodiment of any one of the apparatuses above, the display is a liquid-crystal display (LCD) or an organic light-emitting diode (OLED).

In another embodiment of any one of the apparatuses above, the display is a lens configured to reflect an image produced by a micro projector.

In a further embodiment of any one of the apparatuses above, the processor is further configured to providing an indication of a system status using the display.

In another embodiment of any one of the apparatuses above, the apparatus further comprises a remote communication module configured to communicate with a smart phone. The processor may be configured to operate with the smart phone to generate the captions based on the first sound.

A further embodiment provides a wearable apparatus for hearing assistance, such as glasses. The wearable apparatus includes at least one microphone; a display configured to be worn in front of a user’s eyes; and a processor. The processor is configured to receive speech from the at least one microphone, generate captions based on the speech, and display the captions using the display.

In another embodiment of the apparatus above, the processor is further configured to identify keywords within the captions and displaying the captions comprises emphasizing the keywords. Emphasizing the keywords may include displaying the keywords in: a colored font, bold, and/or all capital letters.

In a further embodiment of any one of the apparatuses above, the apparatus includes a remote communication module configured to communicate with a smart phone, such as using a Bluetooth transmitter, a Wi-Fi connection, etc. The processor may operate with the smart phone to generate the captions based on the speech.

In another embodiment of any one of the apparatuses above, the processor is further configured to identify a speaker of the speech and to display an indication of an identify of the speaker using the display.

A further embodiment provides a method for hearing assistance. The method includes providing a wearable device, such as glasses. The device has two microphones which are located a separation distance apart. The device also has a display configured to be worn in front of a user’s eyes. A first sound is received at a first time from a first microphone. The first sound is received at a second time from the second microphone. The processor determines a direction of origin of the first sound based on the first time, the second time and the separation distance, and provides a visual indication of the direction of origin of the first sound using the display.

In another embodiment of the method above, the first sound is identified and an indication of an identity of the first sound is provided using the display.

In a further embodiment of any one of the methods above, the wearable device has at least two vibration generators, and the method further comprises providing a vibrational indicator of the direction of origin of the first sound using the at least two vibration generators.

In another embodiment of any one of the methods above, the wearable device is an augmented reality headset.

In a further embodiment of any one of the methods above, the wearable device is a set of glasses.

Another embodiment provides a computer readable medium tangibly encoded with a computer program executable by a processor to preform actions that enable hearing assistance. The actions include receiving a first sound at a first time from a first microphone. The first sound is received at a second time from a second microphone. The processor determines a direction of origin of the first sound based on the first time, the second time and a separation distance between the first microphone and the second microphone. The actions also include providing a visual indication of the direction of origin of the first sound using a display.

In a further embodiment of the computer readable medium above, the first sound is identified and an indication of an identity of the first sound is provided using the display.

In another embodiment of any one of the computer readable media above, the actions further include providing a vibrational indicator of the direction of origin of the first sound using at least two vibration generators.

In a further embodiment of any one of the methods above, the processor is disposed in a set of glasses.

In another embodiment of any one of the methods above, the processor is disposed in an augmented reality headset.

In a further embodiment of any one of the computer readable media above, the computer readable medium is a storage medium.

In another embodiment of any one of the computer readable media above, the computer readable medium is a non-transitory computer readable medium (e.g., CD-ROM, RAM, flash memory, etc.). Various operations described are purely exemplary and imply no particular order. Further, the operations can be used in any sequence when appropriate and can be partially used. With the above embodiments in mind, it should be understood that additional embodiments can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared, and otherwise manipulated.

Any of the operations described that form part of the presently disclosed embodiments may be useful machine operations. Various embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The procedures, processes, and/or modules described herein may be implemented in hardware, software, embodied as a computer-readable medium having program instructions, firmware, or a combination thereof. For example, the functions described herein may be performed by a processor executing program instructions out of a memory or other storage device.

The foregoing description has been directed to particular embodiments. However, other variations and modifications may be made to the described embodiments, with the attainment of some or all of their advantages. Modifications to the above-described systems and methods may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

What is claimed is:

1. A wearable apparatus for hearing assistance, the wearable apparatus comprising:
a first microphone and a second microphone, wherein the first microphone is located a separation distance from the second microphone;
a display configured to present images in front of a user’s eyes; and
a processor configured to:
receive a first sound at a first time from the first microphone,
receive the first sound at a second time from the second microphone,
determine a direction of origin of the first sound based on the first time, the second time and the separation distance, and
provide a visual indication of the direction of origin of the first sound using the display.

2. The wearable apparatus as in claim 1, wherein the processor is further configured to identify the first sound and to provide an indication of an identity of the first sound using the display.

3. The wearable apparatus as in claim 1, wherein the apparatus further comprises at least two vibration generators, and the processor is further configured to providing a vibrational indicator of the direction of origin of the first sound using the at least two vibration generators.

4. The wearable apparatus as in claim 1, wherein the processor is further configured to generate captions based on the first sound and to display the captions using the display.

5. The wearable apparatus as in claim 4, wherein the processor is further configured to identify keywords within the captions and wherein displaying the captions comprises emphasizing the keywords.

6. The wearable apparatus as in claim 5, wherein emphasizing the keywords comprises displaying the keywords in at least one of: a colored font, bold, and all capital letters.

7. The wearable apparatus as in claim 1, wherein the processor is further configured to providing an indication of a system status using the display.

8. The wearable apparatus as in claim 1, wherein the apparatus further comprises a remote communication module configured to communicate with a smart phone.

9. The wearable apparatus as in claim 8, wherein the processor is further configured to operate with the smart phone to generate the captions based on the first sound.

10. A wearable apparatus for hearing assistance, the wearable apparatus comprising:
at least one microphone;
a display configured to present images in front of a user’s eyes; and
a processor configured to:
receive speech from the at least one microphone,
generate captions based on the speech, and
display the captions using the display.

11. The wearable apparatus as in claim 10, wherein the processor is further configured to identify keywords within the captions and wherein displaying the captions comprises emphasizing the keywords.

12. The wearable apparatus as in claim 11, wherein emphasizing the keywords comprises displaying the keywords in at least one of: a colored font, bold, and all capital letters.

13. The wearable apparatus as in claim 10, wherein the apparatus further comprises a remote communication module configured to communicate with a smart phone.

14. The wearable apparatus as in claim 13, wherein the processor is further configured to operate with the smart phone to generate the captions based on the speech.

15. The wearable apparatus as in claim 10, wherein the processor is further configured to identify a speaker of the speech and to display an indication of an identify of the speaker using the display.

16. A computer readable medium tangibly encoded with a computer program executable by a processor to perform actions for hearing assistance, the actions comprising:
receiving a first sound at a first time from a first microphone,
receiving the first sound at a second time from a second microphone,
determining a direction of origin of the first sound based on the first time, the second time and a separation distance between the first microphone and the second microphone, and
providing a visual indication of the direction of origin of the first sound using a display configured to present images in front of a user’s eyes.

17. The computer readable medium as in claim 16, wherein the actions further comprise identifying the first sound and providing an indication of an identity of the first sound using the display.

18. The computer readable medium as in claim 16, wherein the actions further comprise providing a vibrational indicator of the direction of origin of the first sound using at least two vibration generators.

19. The computer readable medium as in claim 16, wherein the processor, the first microphone, the second microphone and the display are located in a wearable device.

20. The computer readable medium as in claim 16, wherein the wearable device is a set of glasses.
